(19) United States
(12) Patent Application Publication
(10) Pub. No.: US 2008/0307724 A1
(43) Pub. Date: Dec. 18, 2008

(54) Linking kit for panel structures

(76) Inventors: Eric Krantz-Lilienthal, Janesville, WI (US); Stephen M. Newcomer, Landisville, PA (US); Paul A. Hough, Lititz, PA (US)

Correspondence Address: John M. Olivo;Armstrong World Industries, Inc., 2500 Columbia avenue, P.O. Box 3001, Lancaster, PA, 17604-3001, US

(21) Appl. No.: 12/154,828

(22) Filed: May 27, 2008

Related U.S. Application Data
(60) Provisional application No. 60/931,617, filed on May 24, 2007.

(51) Int. Cl. E04B 1/38; E05D 3/06

(52) U.S. Cl. 52/222; 16/366

(57) ABSTRACT

The present invention relates generally to an accent system which is supported and/or hung from the primary building structure. The system includes a group of accent structures and kits for spacing and linking the accent structures.

### CROSS REFERENCE TO RELATED APPLICATION

This application claims the benefit under 35 U.S.C. § 119(e) of U.S. provisional application Ser. No. 60/931,617, filed May 24, 2007.

### BACKGROUND OF THE INVENTION

The present invention relates generally to an accent system having a group of accent structures which are supported and/or hung from the primary building structure. More specifically, the present invention relates to kits for spacing and linking groups of accent structures.

Designers and architects often object to the uniformity and lowered ceiling height created by conventional suspended ceilings. As a result, more and more businesses are opting for so-called open plenum, or loft-style, ceiling designs. In these loft-style spaces, designers and architects often require the space overhead to include customized accent structures in order to enhance aesthetic appeal, differentiate the space and dampen extraneous noise.

Armstrong World Industries, Inc. has designed several accent systems for use in these loft-style spaces. Co-pending U.S. Patent Application Publication No. 2004/0182022 (hereinafter “the '022 application”) illustrates and describes one such system. The '022 application covers an accent structure having an edge strip which cooperates with opposing edges of a flexible panel. Each edge strip has an arcuate channel which is positioned proximate and parallel to the longitudinal edge of the strip. A slot extends from the arcuate channel to the longitudinal edge of the strip. The slot is dimensioned such that the spacing between the side surfaces of the slot is less than the diameter of the arcuate channel. The edge strip further includes at least one mounting hardware receiving area dimensioned to receive mounting hardware. The mounting hardware includes, but is not limited to: kits for hanging the accent structures from an overhead deck or existing ceiling; kits for attaching the accent structures to walls; and kits for spacing and linking groups of accent structures.

The present invention increases the flexibility and aesthetic appeal of a system containing groupings of accent structures and provides a solution for spacing and linking groups of accent structures in one or more axis.

### SUMMARY OF THE INVENTION

The invention is directed to an accent system having a grouping of accent structures. The accent system includes first and second accent structures. Each of the first and second accent structures has a panel and at least one edge strip which cooperates with an edge of the panel. The accent system further includes a linking kit for attaching the edge strips of the first and second accent structures to one another such that the accent structures are attached to one another in an end-to-end relation. The linking kit includes a hinge, a linking rod and a retaining ring. By positioning the linking kit proximate the outside edge of the edge strip, at least a third accent structure having a panel and edge strip combination can be attached to at least one of the first and second accent structures in a side-to-side relation, thereby grouping the accent structures in more than one axis.

Functional benefits of the dual hinge kit include: nearly unlimited installation angles for freedom of design; positive, or fixed, registration of panels positioned in an end-to-end and side-to-side relation; and elimination of redundant suspension cabling.

### BRIEF DESCRIPTION OF THE DRAWINGS

FIG. 1 is a perspective view of a first example embodiment of the accent system of the invention.

FIG. 2A is a partial perspective view of a single hinge linking kit linking two edge strips in end-to-end relation using.

FIG. 2B is an exploded perspective view of the single hinge linking kit of FIG. 2A.

FIG. 3A is a partial perspective view of a first example embodiment of a dual hinge linking kit in which paired edge strips are liked end-to-end and have no space side-to-side.

FIG. 3B is an exploded perspective view of the dual hinge linking kit of FIG. 3A.

FIG. 4A is a partial perspective view of a second example embodiment of a dual hinge linking kit in which paired of edge strips are linked end-to-end and are spaced side-to-side.

FIG. 4B is an exploded perspective view of the dual hinge linking kit of FIG. 4A.

FIG. 5A is a partial perspective view of a third example embodiment of a dual hinge linking kit in which paired edge strips are linked end-to-end and are spaced side-to-side.

FIG. 5B is an exploded perspective view of the dual hinge linking kit of FIG. 5A.

FIG. 6 is a perspective view of a first example embodiment of the accent system of the invention.

FIG. 7 is a perspective view of a third example embodiment of the accent system of the invention.

FIG. 8 is a perspective view of a fourth example embodiment of the accent system of the invention.

FIG. 9 is a perspective view of a fifth example embodiment of the accent system of the invention in which accent structures of varying size are utilized.

FIG. 10 is a perspective view of a sixth example embodiment of the accent system of the invention in which accent structures of varying size are utilized.

FIG. 11 is a perspective view of a seventh example embodiment of the accent system of the invention in which accent structures of varying size are utilized.

FIG. 12 is a perspective view of an adjacent edge strips which are linked to one another via an alternative example embodiment of the linking kit of the invention.

FIG. 13A-D are perspective views of alternative linking kits

FIG. 14 is an exploded perspective view of FIG. 13C.

FIG. 15A is perspective view of FIG. 13D showing the rotational capability of the hinge.

FIG. 15B is an exploded perspective view of FIG. 13D.

### DETAILED DESCRIPTION OF THE DRAWINGS

Referring now in greater detail to the figures, wherein like numerals refer to like parts throughout the drawings. The accent systems 10 illustrated throughout the drawings include at least two accent structures 12. Each accent structure 12 includes a panel 14, preferably a flexible panel of rectilinear configuration, and an edge strip 16 which cooperates with an edge of the panel 14.

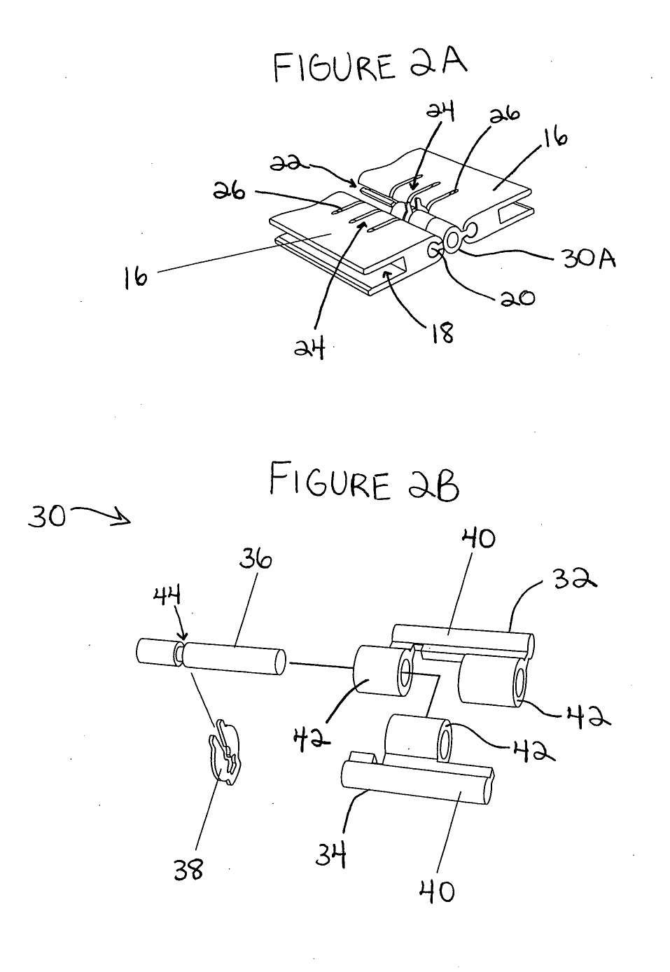

As shown in FIG. 2, each edge strip 16, which is shown in the drawings as an aluminum extrusion, has a panel receiving recess 18 which extends the entire length of the strip. The panel receiving recess 18 is dimensioned to receive an edge of the panel 14 therein. The edge strip 16 also includes an arcuate channel 20 which extends the entire length of the edge strip 16. The arcuate channel 20 is spaced from, and positioned substantially parallel to, the panel receiving recess 18. A longitudinal slot 22 extends from the arcuate channel 20 to the edge of the strip 16. The slot 22 is dimensioned such that the spacing between the side surfaces of the slot is less than the diameter of the arcuate channel 20.

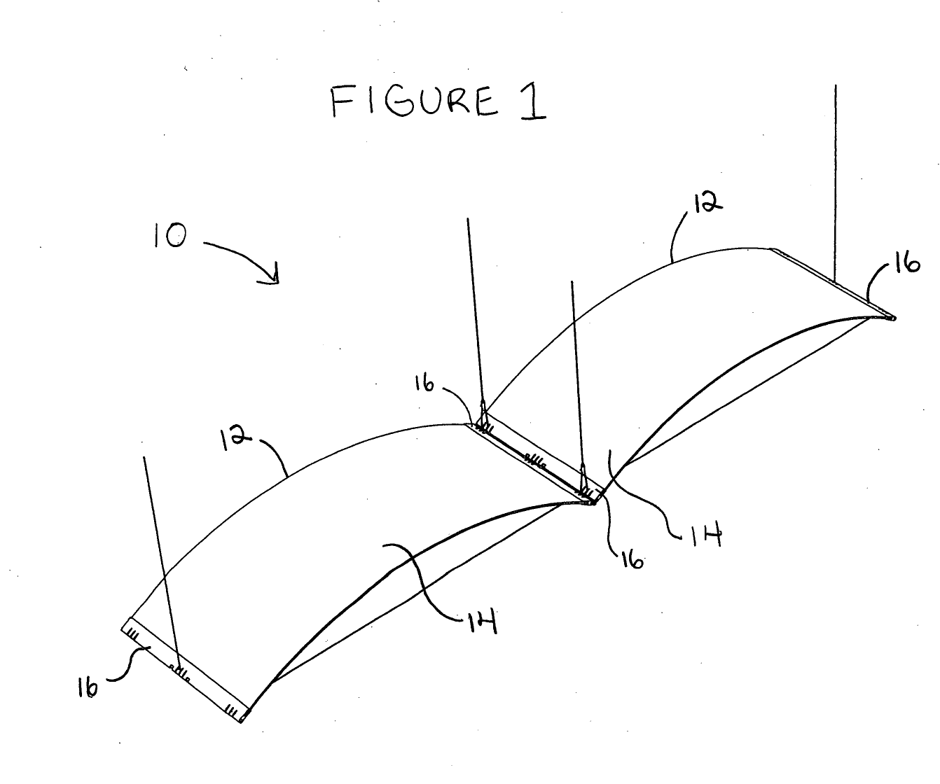

The edge strip 16 also includes at least one mounting hardware receiving area 24 provided thereon for receiving mounting hardware therein. In the embodiments illustrated throughout the figures, the mounting hardware receiving area 24 is preferably positioned proximate the outer ends of the edge strip 16. However, the mounting hardware receiving area 24 can be positioned anywhere along the edge strip 16, e.g. proximate the center of the edge strip 14 as shown in FIG. 1. Each mounting hardware receiving area 24 has at least one mounting hardware receiving slot 26 which extend from the surface of the strip 16 and into the arcuate channel 20. The longitudinal axis of each receiving slot 26 is essentially perpendicular to the longitudinal axis of the arcuate channel 20. While three receiving slots 26 are shown, various numbers and configurations of slots 26 may be provided without departing from the scope of the invention. In the embodiments shown thorough the drawings, tension cables 15 and suspension cables 17 are strung throughout the edge strips of an accent structure to form a panel having an arc and to support the panel from the building structure at varying heights.

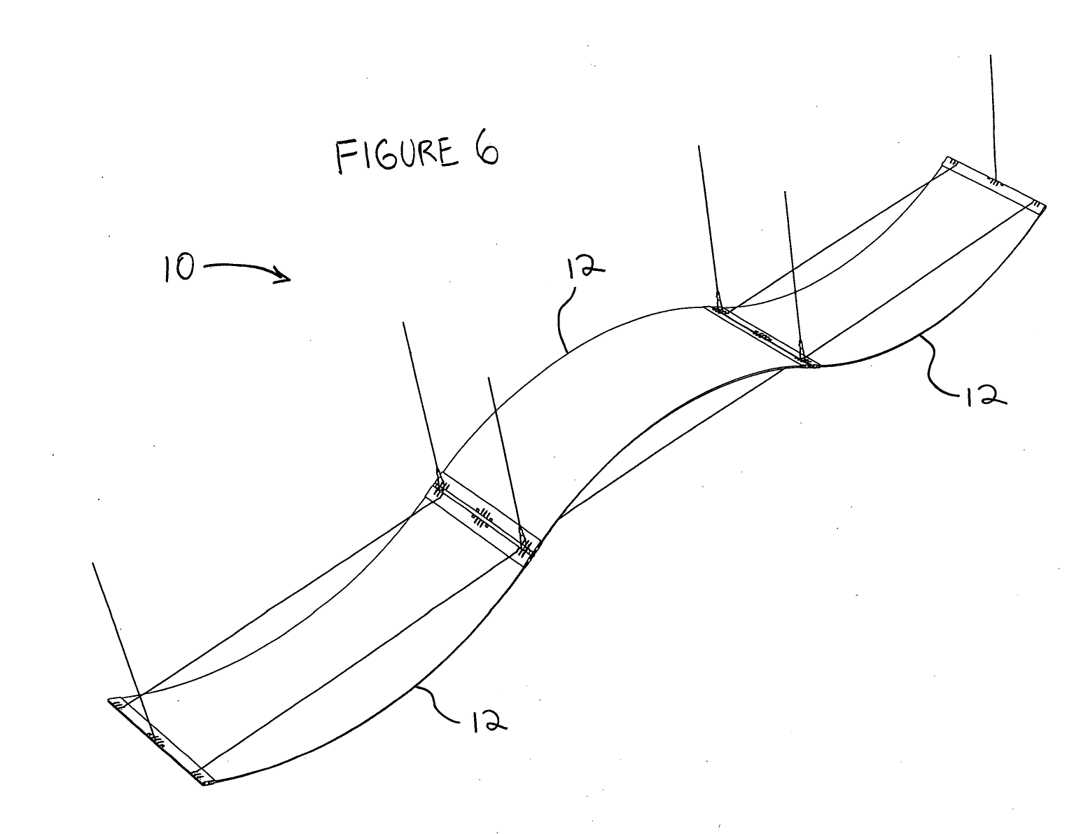

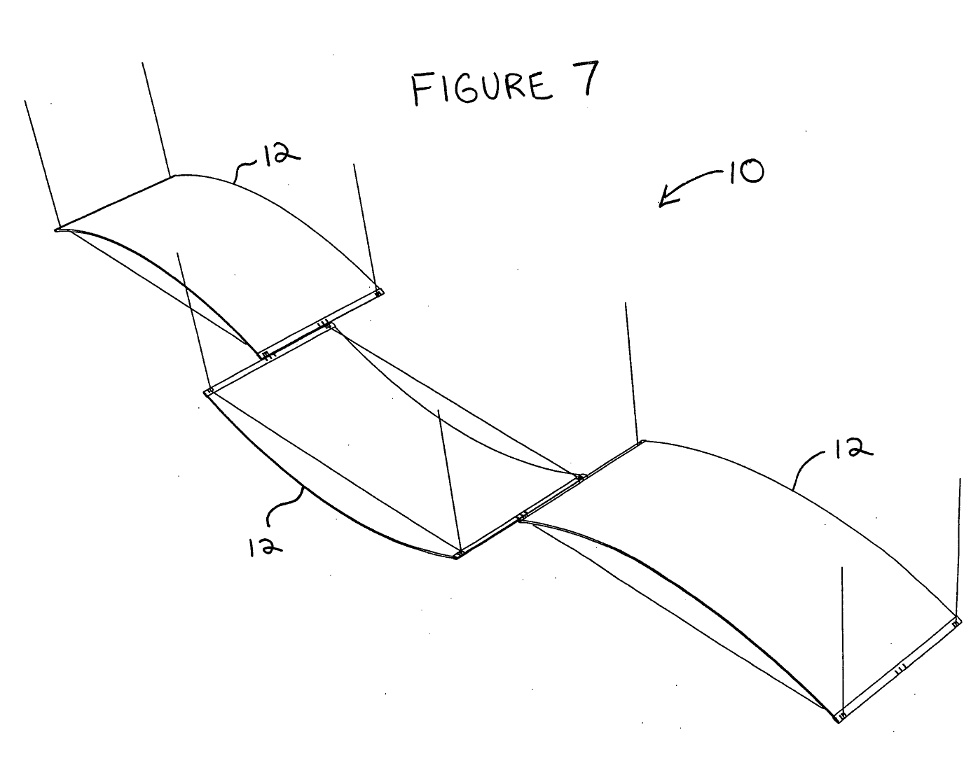

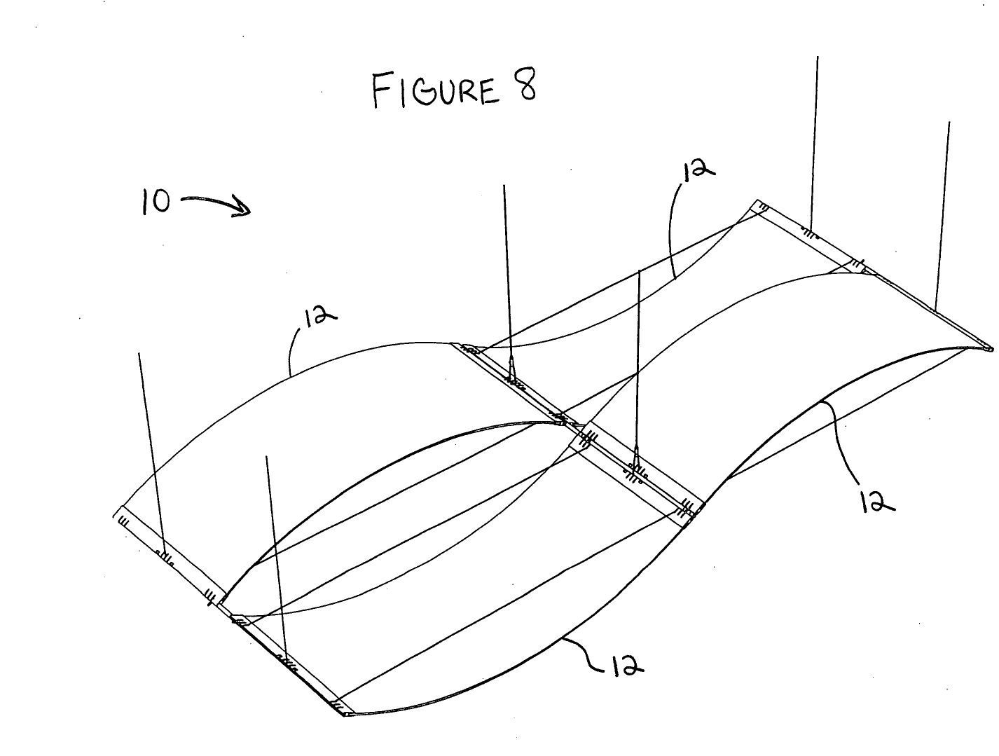

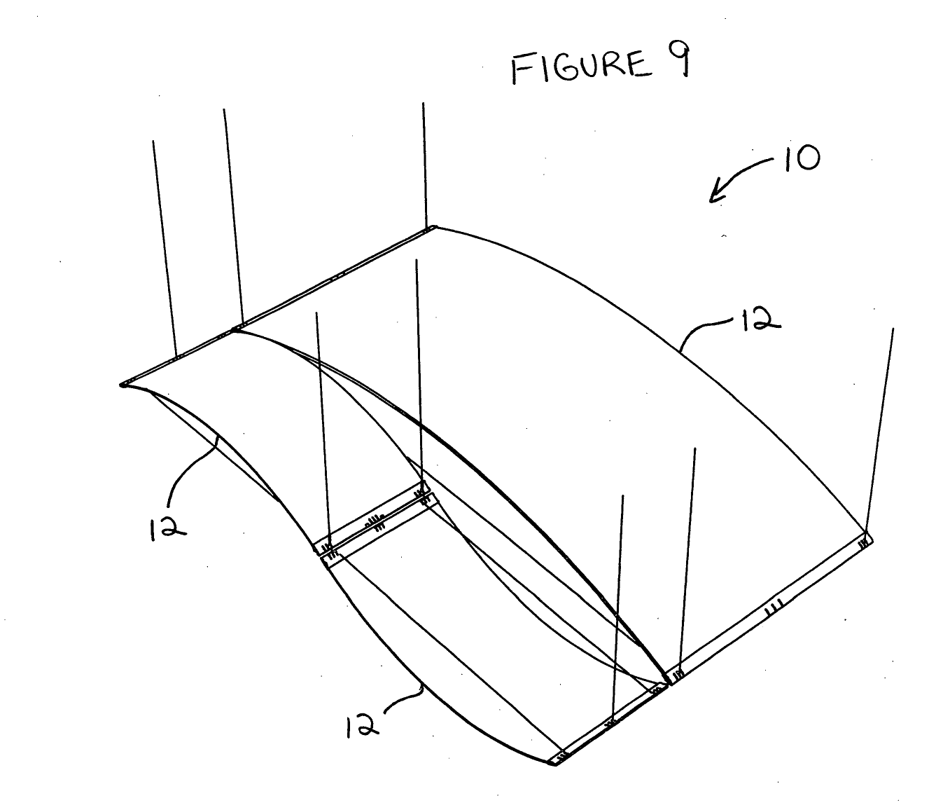

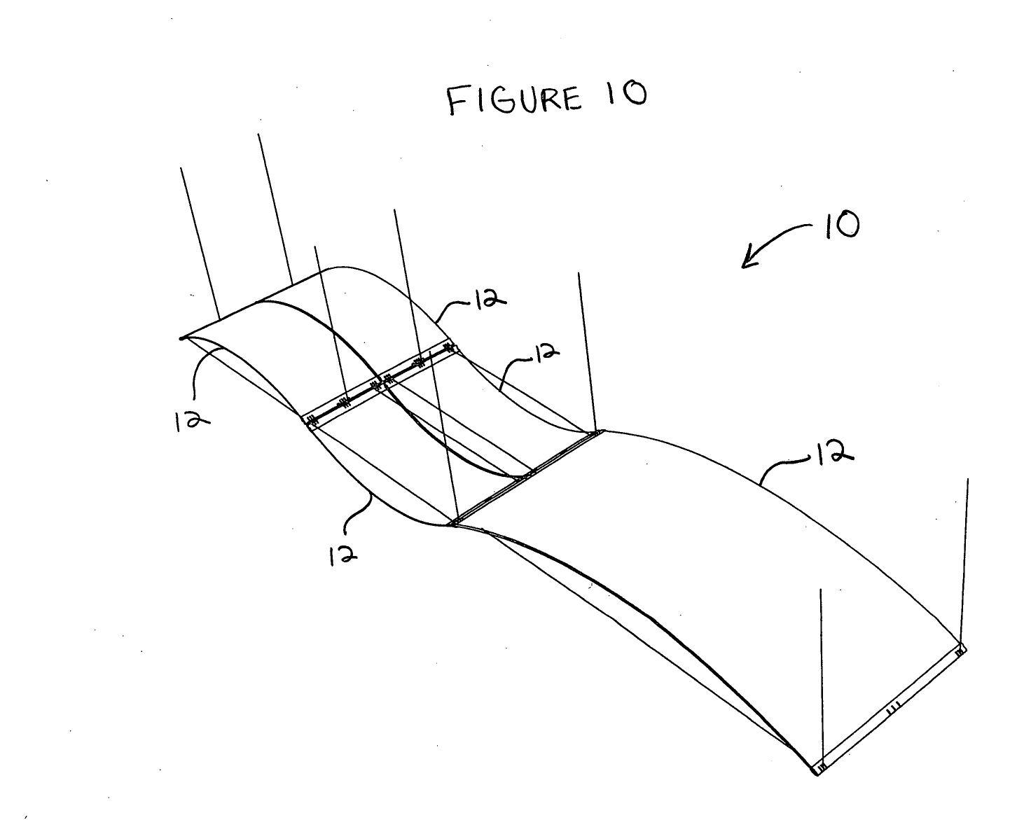

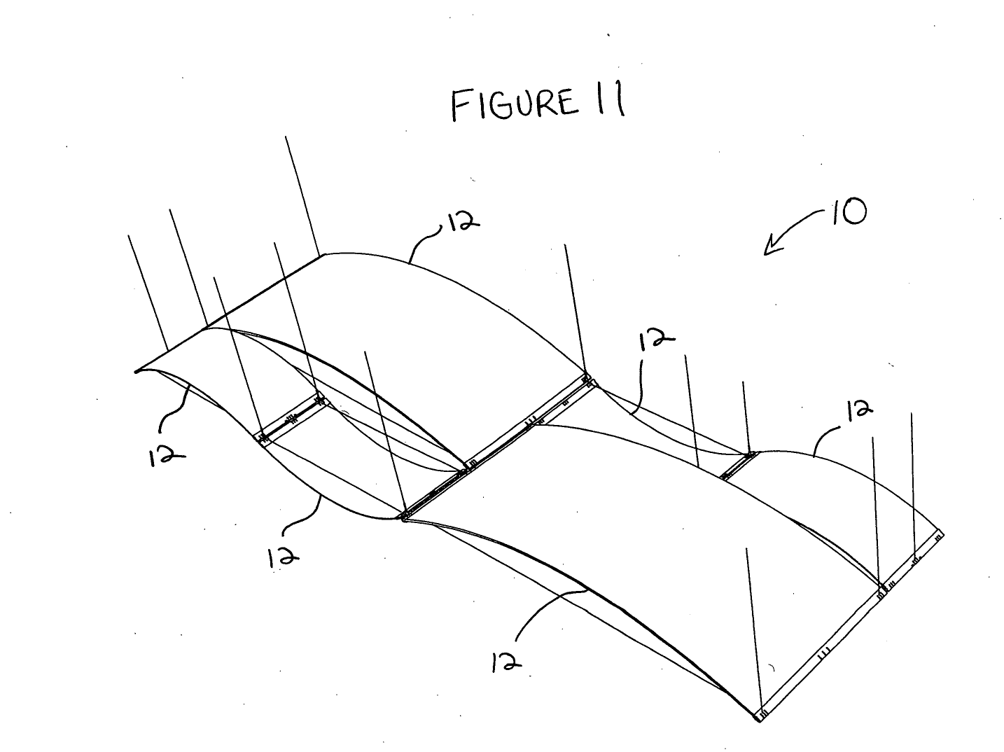

FIGS. 6-12 provide example illustrations of how a grouping of accent structures of the same, or of varying shapes, can be linked relative to one another. FIGS. 2A and 2B illustrate a first example embodiment of a kit for linking two accent structures 12 to one another in an end-to-end relation. As best shown in FIG. 2B, the first example linking kit 30 includes a hinge which has first and second hinge members, 32 and 34 respectively. The linking kit also includes a linking rod 36 and an external retaining clip 38. Each hinge member has an edge strip attachment portion 40 and at least one hollow cylinder 42. As shown in FIG. 2A, the edge strip attachment portion 40 is dimensioned such that it can be received in the arcuate channel 20 of an edge strip. More specifically, the attachment portion can be inserted through the outer edge of a respective edge strip 16 and into the arcuate channel 20 until the attachment portion, and, in turn, the hinge member, is in alignment with a mounting hardware area 24 of the edge strip 16.

The linking rod 36 is dimensioned to be received in the hollow cylinders 42 of both the first and second hinge members 32, 34. The linking rod 36 has at least one clip receiving recess 44 which extends about the circumference of the rod 36. The linking rod 36 is slid through the hollow cylinders 42 of both the first and second hinge members 32, 34 until the clip receiving recess 44 is aligned with a mounting hardware receiving slot 26. A clearance is provided between mated hollow cylinders of the first and second hinge members for insertion of the retaining clip 38. To maintain the linking rod in position, as well as attach the first and second hinge members to one another, the retaining clip 38, such as a circle clip or wire spring clip, is inserted through mating mounting hardware receiving slots 26 of adjacent edge strips 16 and into engagement with a clip receiving recess 44 in the linking rod 36.

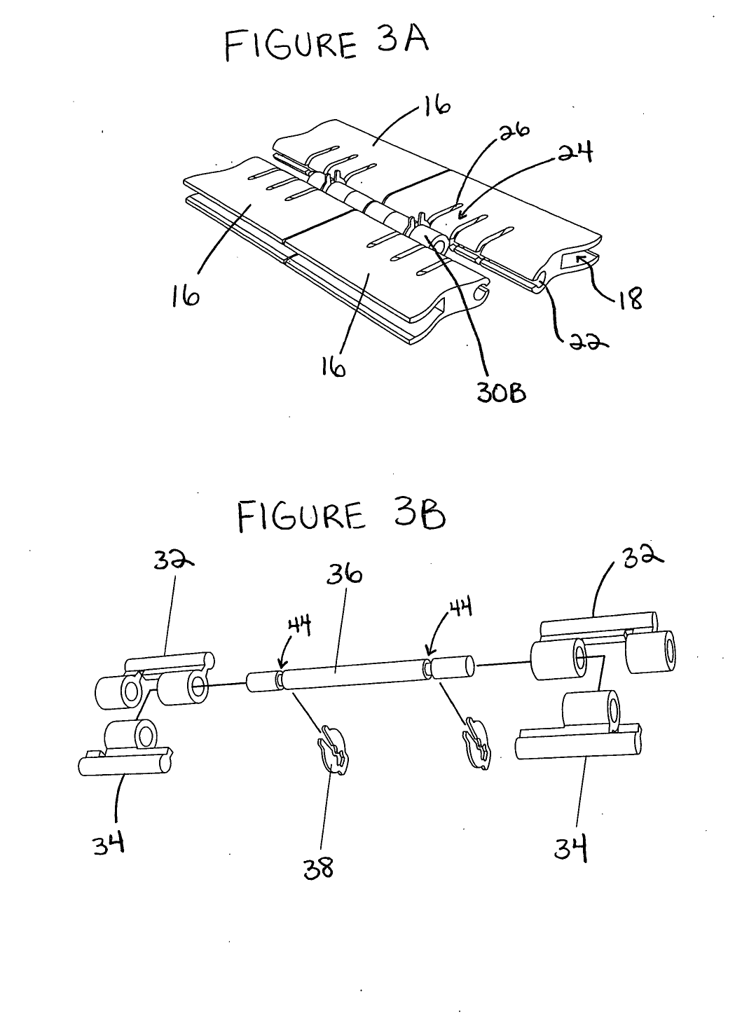

FIGS. 3A and 3B illustrate a second example embodiment of the linking kit which provides the capability of liking four accent structures in both end-to-end and side-to-side relation. In order to attach the accent structures in side-to-side relation, and, therefore, in two axes, a dual hinge linking kit is used. The dual hinge linking kit contains the features of the single hinge linking kit. However, each dual hinge linking kit includes: two hinges; a linking rod which has two clip receiving recesses; and two retaining clips. Additionally, the linking rod of the dual hinge kit must be of sufficient length that the hinge members of more than one hinge can be slid over the linking rod. Thus, the hollow cylinders of the hinge members must have an inside diameter greater than the diameter of the linking rod to allow the hinge members to move freely relative to linking rod.

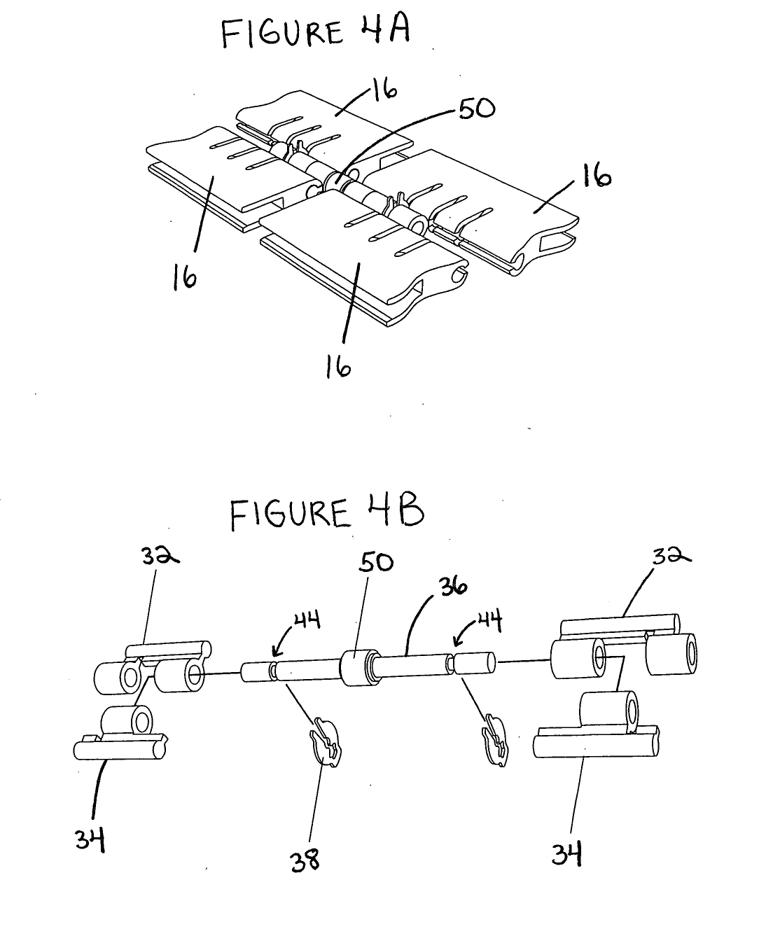

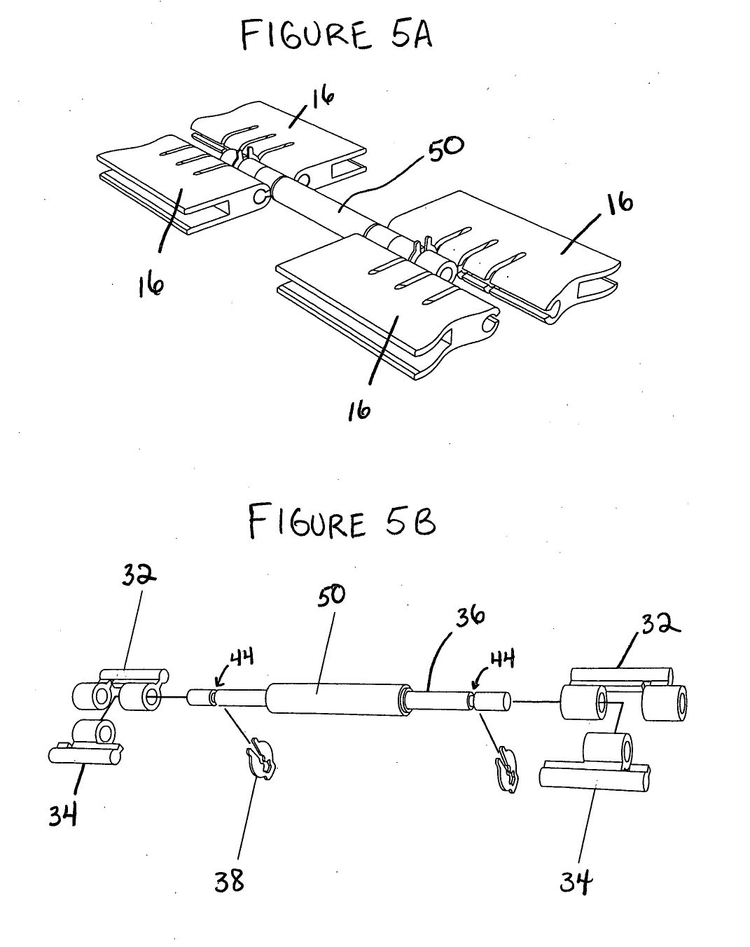

The accent structures in their side-to-side relation can either be positioned contiguous one another as shown in FIG. 3A or spaced apart as shown in FIGS. 4A and 5A. More specifically, as shown in FIGS. 4A and 4B, a spacer 50 can be used to add to the aesthetic value of the system and permit installers to easily align and connect the end-to-end linked accent structures in the desired spaced side-to-side spaced relation (See FIGS. 5A and 5B). The example embodiment of the spacer 50 shown throughout the drawings is a cylindrical member which has an inside diameter greater than the diameter of the linking rod 36, thereby allowing the spacer to move freely relative the linking rod 36. Preferably, the spacer 50 has dimensions similar to, if not exactly the same as, the hollow cylinders 42 of the first and second hinge members 32, 34. The linking rod must be of sufficient length to allow it to project beyond the length of the spacer and dual hinge members such that it can be inserted through the arcuate channel of adjacent edge strips and the clip receiving recesses brought into alignment with the longitudinal slots of the edge strip as described above.

Various other alternative materials, securing methods, profiles and configurations can be used without departing from the scope of the invention. Other changes in construction will occur to those skilled in the art and various apparently different modifications and embodiments may be made without departing from the scope of the invention. The matter set forth in the foregoing description and accompanying drawings is offered by way of illustration only. It is therefore intended that the foregoing description be regarded as illustrative rather than limiting.

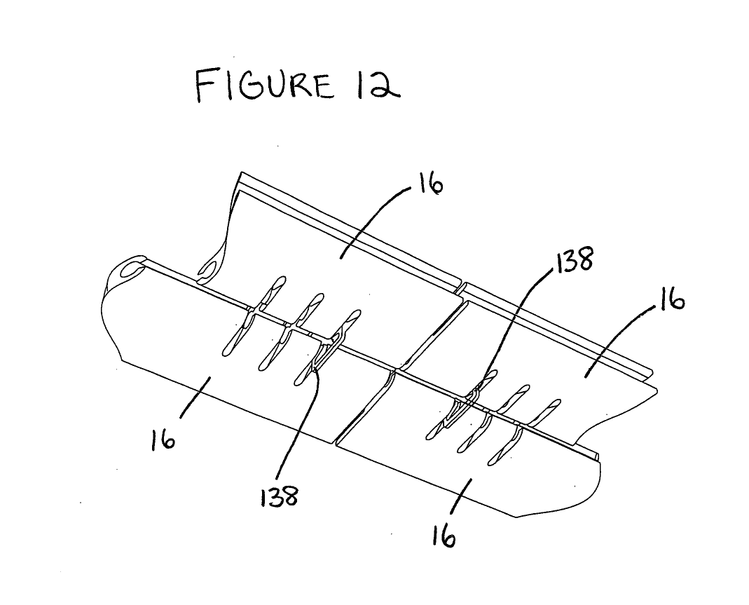

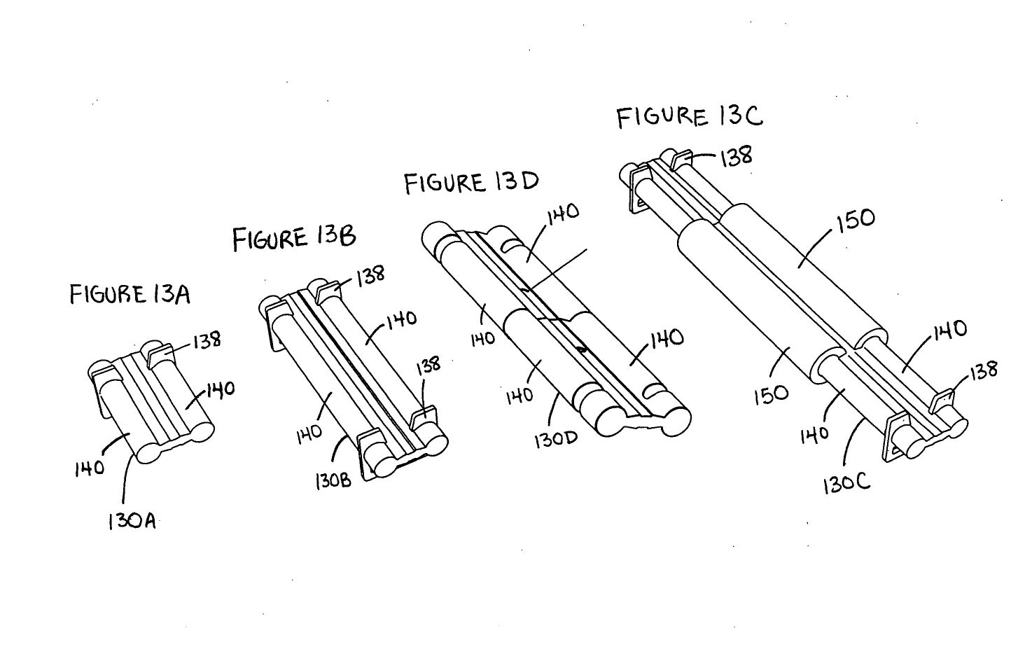

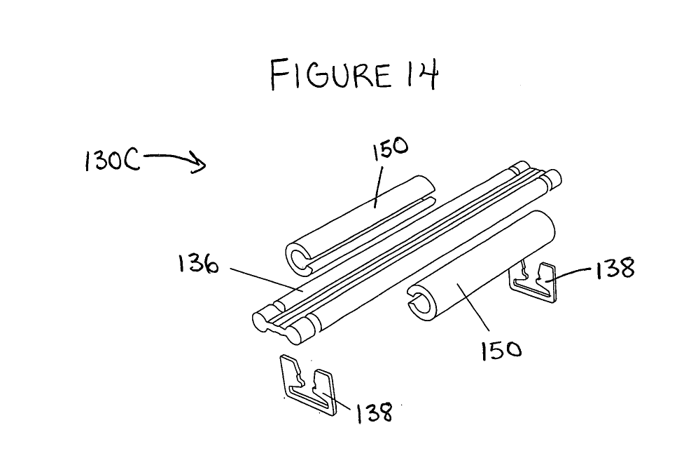

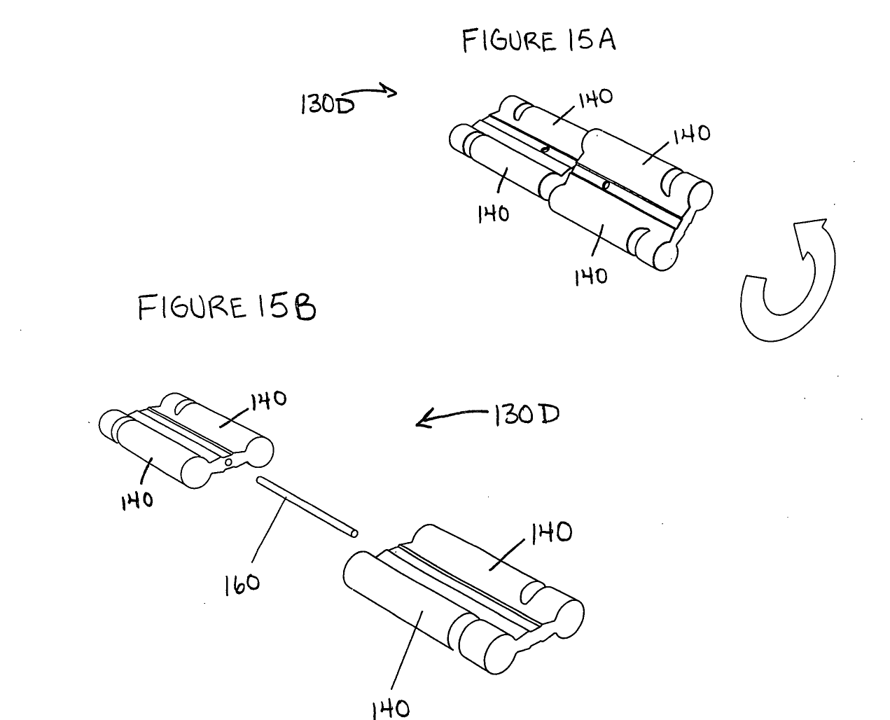

For example, FIGS. 12-15 illustrate variations of the linking kit. FIG. 13A illustrates an alternative embodiment of a hinge member 130A for attaching accent structures in end-to-end relation. FIG. 13B illustrates an alternative embodiment of a hinge member 130B for attaching accent structures in both end-to-end and side-to-side relation. FIGS. 13C and 14 illustrate an alternative embodiment of a hinge member 130C for attaching accent structures in both end-to-end and side-to-side relation which includes a spacer 150. FIGS. 13D, 15A and 15B illustrate an alternative embodiment of a dual hinge member 130D. Each of the hinge members in these alternative example embodiments are extruded members which incorporate some of the features of the hinges described above. For example, these extruded members include a pair of extrusion links 140 which link the accent structures in an end-to-end and, optionally, in side-to-side relation. The alternate linking kits also utilize a spring clip 138 to lock the components of the linking kit to the end strips of the accent structures. The linking kit illustrated in FIGS. 13D and 15A and B utilizes a dual extrusion in which each extrusion contains a pair of extrusion links. The dual extrusions are attached to one another via a cable or pin 160 and are rotatable about the pin such that pairs of end-to-end linked accent structures can be rotated and positioned in side-to-side relation at an angle of zero to ninety degrees.

Further, it is noted that the flexible panel used in these accent structures may be provided in a variety of sizes shapes, materials and finishes and may be formed of wood, paper, metal, plastic, glass or any other suitable material. The panel may be solid, mesh or include a variety of decorative designs or openings therein to provide the desired visual impact. Sizes, shapes, textures and finishes can be mixed and matched to further accentuate a space. Further, the accent structures can either be flexed upward or downward to create a more interesting visual.

We claim:

1. An accent system comprising:
first and second accent structures, the first and second accent structures each having a panel and at least one edge strip which cooperates with an edge of the panel; and
a linking kit for attaching the edge strips of the first and second accent structures to one another whereby the accent structures are attached to one another in an end-to-end relation.

2. The accent system of claim 1, comprising a third accent structure having a panel and edge strip combination, wherein the linking kit attaches the third accent structure in side-to-side relation with at least one of the first or second accent structures.

3. The accent system of claim 2, whereby the first, second and third accent structures are grouped relative one another in more than one axis.

4. The accent system of claim 3, wherein the axes include the longitudinal and transverse axes.

5. The accent system of claim 3, wherein the linking kit includes a single hinge which attaches the first and second accent structures to one another.

6. The accent system of claim 5, wherein the hinge includes first and second hinge members and a linking rod, the linking rod attaching the first and second hinge members to one another.

7. The accent system of claim 6, wherein each hinge member includes an edge strip attachment portion and at least one hollow cylinder.

8. The accent system of claim 6, wherein the hinge members and linking rod are locked to the edge strip via a retaining clip.

9. The accent system of claim 1, wherein the linking kit includes a dual hinge.

10. The accent system of claim 9, wherein the dual hinge includes pairs of first and second hinge members.

11. The accent system of claim 10, wherein the pairs of first and second hinge members are contiguously positioned in side-to-side relation, thereby providing no space therebetween.

12. The accent system of claim 10, wherein the pairs of first and second hinge members are separated by a spacer.

13. The accent system of claim 10, wherein the pairs of first and second hinge members are attached to one another via a linking rod.

14. The accent system of claim 10, wherein each of the first and second hinge members includes an edge strip attachment portion and at least one hollow cylinder.

15. The accent system of claim 1, wherein the linking kit is positioned proximate the outside edge of two adjacent edge strips.
